(19) United States
(12) Patent Application Publication
(10) Pub. No.: US 2004/0065021 A1
(43) Pub. Date: Apr. 8, 2004

(54) Polishing composition

(76) Inventors: Yasuhiro Yoneda, Wakayama-shi (JP); Toshiya Hagihara, Wakayama-shi (JP)

Correspondence Address: BIRCH STEWART KOLASCH & BIRCH, PO BOX 747, FALLS CHURCH, VA, 22040-0747, US

(21) Appl. No.: 10/668,216

(22) Filed: Sep. 24, 2003

(30) Foreign Application Priority Data
Oct. 4, 2002 (JP) 2002-291896

(51) Int. Cl. C09G 1/02; C09G 1/04; B24B 1/00

(52) U.S. Cl. 51/298; 51/307; 51/309; 106/3

(57) ABSTRACT

A polishing composition comprising polymer particles and inorganic particles in an aqueous medium, wherein the inorganic particles have an average particle size of from 5 to 170 nm, and wherein an average particle size Dp (nm) of said polymer particles and an average particle size Di (nm) of said inorganic particles satisfy the following formula (1): Dp≦Di+50 nm (1); a polishing process for a substrate to be polished comprising polishing the substrate to be polished with the polishing composition as defined above; and a process for improving a rate for polishing a substrate to be polished with the polishing composition as defined above. The polishing composition of the present invention can be favorably used in polishing the substrate for precision parts, including semiconductor substrates; substrates for magnetic recording media such as magnetic discs, optical discs and opto-magnetic discs; photomask substrates; glass for liquid crystals; optical lenses; optical mirrors; optical prisms; and the like.

### BACKGROUND OF THE INVENTION

1. Field of the Invention

The present invention relates to a polishing composition. More specifically, the present invention relates to a polishing composition which is capable of efficiently polishing a substrate to be polished at a high polishing rate, which is especially useful for polishing a silicon oxide film, and a polishing process for a substrate to be polished with the polishing composition and a process for increasing a rate for polishing a substrate to be polished with the polishing composition.

2. Discussion of the Related Art

Presently, steps for polishing various substrates have been employed in the production of each kind of a substrate. For instance, in the field of semiconductors, there has been employed a step of polishing a silicon wafer substrate; a compound semiconductor wafer substrate made of a compound such as gallium arsenide, indium phosphide, or gallium nitride; or a silicon oxide film, a metal film made of aluminum, cupper, tungsten or the like, or a nitride film made of silicon nitride, tantalum nitride, titanium nitride or the like, the film being further formed on a wafer. In the field of hard disks, there has been employed a step of polishing an aluminum substrate or glass substrate. In the field of display devices such as lenses and liquid crystals, there has been employed polishing of glass. In the polishing step for these substrates to be polished, the polishing rate is important in order to increase the productivity, and various techniques for increasing the polishing rates have been proposed.

For instance, a polishing compound comprising an aggregate comprising inorganic particles and polymer particles has been disclosed (see Japanese Patent Laid-Open Nos. 2000-269169 and 2000-269170 (each corresponding to EP-A-1036836) and No. 2001-115143). However, there are some risks in these polishing compounds that the dispersion stability of the abrasive grains in the polishing compound is worsened, thereby generating scratches. On the other hand, an aqueous dispersion for chemical-mechanical polishing comprising inorganic particles and polymer particles has been disclosed (Japanese Patent Laid-Open No. 2000-204353 (U.S. Pat. No. 6,375,545)). However, in this aqueous dispersion, while the aqueous dispersion is excellent in an effect for reducing scratches, the inorganic particles have a preferred average particle size of 0.1 μm or more, and the concretely described inorganic particles have too large a size such as 0.18 μm or 0.24 μm. Therefore, an effect of increasing the polishing rate is not found, so that it cannot be said that sufficient polishing rate is achieved.

### SUMMARY OF THE INVENTION

According to the present invention, there are provided:

[1] a polishing composition comprising polymer particles and inorganic particles in an aqueous medium, wherein the inorganic particles have an average particle size of from 5 to 170 nm, and wherein an average particle size Dp (nm) of the polymer particles and an average particle size Di (nm) of the inorganic particles satisfy the following formula (1):

Dp≧Di+50 nm (1)

[2] a polishing process for a substrate to be polished comprising polishing the substrate to be polished with the polishing composition as defined in the above [1]; and

[3] a process for improving a rate for polishing a substrate to be polished with the polishing composition as defined in the above [1].

### BRIEF DESCRIPTION OF THE DRAWINGS

FIG. 1 is a schematic view showing stepwise the formation of an aggregate composite particle from the polymer particles and the inorganic particles in the polishing composition when a strong shearing force is applied during polishing.

FIG. 2 is a graph schematically showing the relationship between an average particle size Dp of the polymer particles and an average particle size Di of the inorganic particles in connection with the polishing rates in Examples 1 to 3 and 5 to 11 and Comparative Examples 7 to 10, wherein “E” stands for Example, and “CE” stands for Comparative Example, respectively, and wherein “◯” means that the polishing rate of the polishing composition in each Example is increased as compared to those of a polishing composition composed only of the inorganic particles without the addition of the polymer particles, and “×” means that the polishing rate of the polishing composition in each Example is of the same level as or decreased as compared to those of a polishing composition composed only of the inorganic particles without the addition of the polymer particles.

### DETAILED DESCRIPTION OF THE INVENTION

The present invention relates to a polishing composition capable of polishing a substrate to be polished made of silicon, glass, an oxide, a nitride or a metal, or a coated substrate thereof at a high rate, and generating little scratches, a polishing process for a substrate to be polished with the polishing composition, and a process for increasing a rate for polishing a substrate to be polished with the polishing composition.

These and other advantages of the present invention will be apparent from the following description.

As described above, the polishing composition of the present invention comprises polymer particles and inorganic particles in an aqueous medium, wherein the inorganic particles have an average particle size of from 5 to 170 nm, and wherein an average particle size Dp (nm) of the polymer particles and an average particle size Di (nm) of the inorganic particles satisfy the following formula (1):

Dp≦Di+50 nm (1)

In the present invention, since the polishing composition has the above constitution, there is exhibited an effect that the polishing composition can be used for polishing a substrate to be polished made of silicon, glass, an oxide, a nitride or a metal, or a coated substrate thereof at a high rate.

The polymer particles used in the present invention include particles made of a thermoplastic resin and particles made of a thermosetting resin. The thermoplastic resin includes polystyrenic resins, (meth)acrylic resins, polyolefin resins, polyvinyl chloride resins, elastomeric resins, polyester resins, polyamide resins, polyacetal resins, and the like. The thermosetting resin includes phenolic resins, epoxy resins, urethane resins, urea resins, melamine resins, and the like. The particles made of the thermoplastic resin as the resin are preferable, from the viewpoint of increasing the polishing rate. Among them, the particles made of a polystyrenic resin or a (meth)acrylic resin are especially preferable.

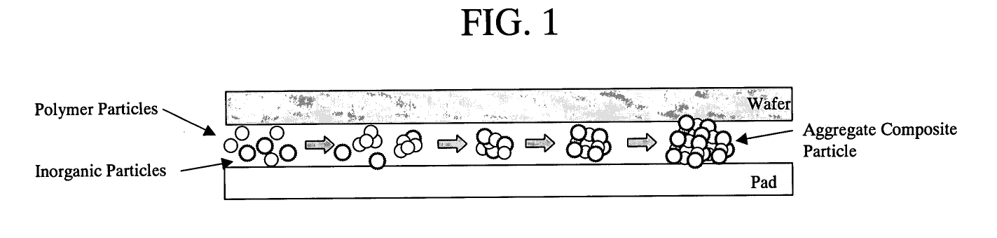

In a case where the polymer particles are particles made of a thermoplastic resin, there is a dramatic effect for increasing the polishing rate. Although the reason for such an effect is not clear, it is presumably as follows. If a strong shearing force is applied to a polishing composition during polishing, the polymer particles are aggregated with incorporating the inorganic particles into the polymer particles, so that an aggregate composite particle having high polishing power is formed (see FIG. 1). When the polymer particles are particles made of a thermoplastic resin, this aggregate composite particle tends to be formed and grown, thereby enhancing the effect for increasing the polishing rate.

The polystyrenic resin includes polystyrenes and styrenic copolymers. The styrenic copolymer is a copolymer of styrene and various unsaturated ethylenic monomers, and the copolymerizable unsaturated ethylenic monomer includes carboxylic acid monomers such as acrylic acid, methacrylic acid, itaconic acid, maleic acid and fumaric acid; (meth)acrylic ester monomers such as methyl (meth)acrylate, ethyl (meth)acrylate, butyl (meth)acrylate and 2-ethylhexyl (meth)acrylate; sulfonic acid monomers such as sodium styrenesulfonate and 2-acrylamide-2-methylpropane sulfonic acid; amino-based monomers such as dimethylaminoethyl methacrylate, dimethylaminopropyl methacrylamide and vinylpyridine; quaternary ammonium salt-based monomers such as methacrylamide propyl trimethyl ammonium chloride and methacryloyloxyethyl trimethyl ammonium chloride; nonionic monomers such as 2-hydroxyethyl methacrylate and methoxypolyethylene glycol methacrylate; cross-linkable monomers such as divinylbenzene, ethylene glycol dimethacrylate, ethylenebis acrylamide and trimethylolpropane trimethacrylate; and the like.

The (meth)acrylic resin includes polymethyl (meth)acrylate, polyethyl (meth)acrylate, polybutyl (meth)acrylate, poly-2-ethylhexyl (meth)acrylate, acrylic copolymers, and the like. The acrylic copolymer includes copolymers of one or more (meth)acrylic monomers such as methyl (meth)acrylate, ethyl (meth)acrylate, butyl (meth)acrylate and 2-ethylhexyl (meth)acrylate with various unsaturated ethylenic monomers. The copolymerizable unsaturated ethylenic monomer includes the same monomers as those for the styrenic copolymers.

Especially, when the polymer particles are made of a polystyrenic resin or a (meth)acrylic resin, the polymer particles can be cross-linked and used. The cross-linking can be carried out by properly copolymerizing the polymer particles with the above-mentioned copolymerizable cross-linkable monomers. The extent of the cross-linking can be expressed by a degree of cross-linking. The lower the degree of cross-linking the more preferable from the viewpoint of an effect for increasing the polishing rate per amount of the polymer particles. Concretely, it is desired that the degree of cross-linking is 50 or less, preferably 30 or less. When the polymer particles are particles made of a resin having a degree of cross-linking of 50 or less, the effect for increasing the polishing rate is high. Although the reason for such an effect is not clear, it is presumably as follows. When the polymer particles are particles made of a resin having a degree of cross-linking of 50 or less, if a strong shearing force is applied to a polishing composition during polishing, the polymer particles are aggregated with incorporating the inorganic particles into the polymer particles, so that an aggregate composite particle having high polishing power is likely to be formed and grown. Consequently, the effect of increasing the polishing rate is enhanced (see, for instance, FIG. 1). In addition, the degree of cross-linking is higher the more preferable, from the viewpoint of increasing the uniformity on a given side of the side to be polished. Concretely, it is desired that the degree of cross-linking is 0.5 or more, preferably 1 or more. Here, the degree of cross-linking refers to a percent by weight of an initially charged copolymerizable cross-linkable monomer per polymer.

The resin constituting the polymer particles is preferably those having a glass transition temperature of 200° C. or lower from the viewpoint of an effect of increasing the polishing rate, more preferably 180° C. or lower, still more preferably 150° C. or lower. The resin having a glass transition temperature of 200° C. or lower includes resins such as polyethylene (−120° C.), polypropylene (−10° C.), polystyrene (100° C.), polymethyl acrylate (3° C.), polymethyl methacrylate (115° C.: syndiotactic, 45° C.: isotactic), polybutyl methacrylate (21° C.), polyvinyl chloride (87° C.), polychloroprene (−50° C.) and polyvinyl acetate (28° C.). The values of the glass transition temperatures are those described in “Kobunshi to Fukugozairyo no Rikigakuteki Seishitsu (Mechanical Characteristics of Polymers and Composite Materials,” 316-318, published by K. K. Kagaku Dojin. When the polymer particles are particles made of a resin having a glass transition temperature of 200° C. or lower, the effect for increasing the polishing rate is high. Although the reason for such an effect is not clear, it is presumably as follows. When the polymer particles are particles comprising a resin having a glass transition temperature of 200° C. or lower, if a strong shearing force is applied to a polishing composition during polishing, the polymer particles are aggregated with incorporating the inorganic particles into the polymer particles, so that an aggregate composite particle having high polishing power is likely to be formed and grown. Consequently, the effect of increasing the polishing rate is enhanced (see FIG. 1).

The polymer particles can be obtained by a process of directly obtaining the particles from an unsaturated ethylenic monomer by means of emulsion polymerization, precipitation polymerization or suspension polymerization, a process of subjecting the polymer to emulsion dispersion, or a process of powdering a bulky resin. Furthermore, the polymer particles obtained as described above can be classified as occasion demands and used. Among them, the emulsion polymerization is preferred from the viewpoint that the polymer particles having a useful particle size in the present invention can be easily obtained.

The average particle size of the polymer particles is preferably from 10 to 220 nm, more preferably from 20 to 180 nm, from the viewpoint of increasing the polishing rate and from the viewpoint of preventing precipitation and separation of the polymer particles. The average particle size can be determined by light scattering method or light diffraction method.

In the present invention, as the inorganic particles, an abrasive generally used for polishing can be used. The abrasive includes, for instance, metals; carbides of metals or metalloids, nitrides of metals or metalloids, oxides of metals or metalloids, borides of metals or metalloids, diamond, and the like. The metals or metalloids include those elements belonging to the Group 3A, 4A, 5A, 3B, 4B, 5B, 6A, 7A or 8 of the Periodic Table (long period form). Examples of the abrasive include silicon dioxide, aluminum oxide, cerium oxide, titanium oxide, zirconium oxide, silicon nitride, manganese dioxide, silicon carbide, zinc oxide, diamond and magnesium oxide. Among them, silicon dioxide, aluminum oxide and cerium oxide are preferable, and concrete examples thereof include the silicon dioxide such as colloidal silica particles, fumed silica particles and surface-modified silica particles; the aluminum oxide such as α-alumina particles, γ-alumina particles, δ-alumina particles, θ-alumina particles, η-alumina particles, amorphous alumina particles, and fumed alumina particles or colloidal alumina particles made from different preparation processes; the cerium oxide such as those having an oxidation state of 3 or 4 and having a hexagonal, isometric, or face-centered cubic system. Further, among them, the colloidal silica particles are especially preferable because the particles have a particle shape of nearly spherical, which can be stably dispersed for a long time period in a primary particle state. The colloidal silica particles can be prepared by a sodium silicate method using an alkali metal silicate such as sodium silicate as a raw material, or an alkoxysilane method using tetraethoxysilane or the like as a raw material. These inorganic particles may be used alone or in admixture of two or more kinds.

The average particle size of the inorganic particles is from 5 to 170 nm, and the average particle size is preferably from 10 to 160 nm, more preferably from 20 to 130 nm, still more preferably from 20 to 95 nm, from the viewpoint of increasing the polishing rate and from the viewpoint of preventing precipitation and separation of the inorganic particles. The average particle size of the inorganic particles for those forming a secondary aggregate such as fumed silica is an average secondary particle size as determined by light diffraction method or light scattering method, and the average particle size for those in which the particles such as colloidal silica exist as monodisperse particles is an average primary particle size calculated using a specific surface area as determined by BET method. Here, the particle size (nm) obtained according to the BET method is calculated by the equation of:

6000/(Specific Gravity [g/cm³]/Specific Surface Area [m²/g]).

Here, in a case where the surface shape of the inorganic particles is porous so that an accurate particle size cannot be determined by the BET method, the average particle size is one determined by ultracentrifugal analysis method. The ultra-centrifugal analysis method includes the method described in “Particle & Particle Systems Characterization 12 (1995), 148-157.”

In addition, the average particle size Dp (nm) of the polymer particles and the average particle size Di (nm) of the inorganic particles satisfy the following formula (1): Dp≦Di+50 nm, preferably satisfying the relationship of Dp≦Di+40 nm, more preferably satisfying the relationship of Dp≦Di+30 nm, from the viewpoint of increasing the polishing rate. Also, Dp and Di satisfies the relationship of preferably Dp≧0.1 Di, more preferably satisfying the relationship of Dp≧0.2 Di, from the viewpoint of availability of the polymer particles. Here, Dp and Di are values for each of the average particle sizes of the polymer particles and the inorganic particles expressed by the unit of “nm.”

When the polymer particles and the inorganic particles are simply mixed, it is preferable not to form an aggregate. When the polymer particles and the inorganic particles are simply mixed, if the polymer particles and the inorganic particles are aggregated, coarse particles are formed, so that there are some risks of causing the generation of scratches and the fluctuation of the polishing rate which are caused by precipitation and separation of the coarse particles. It is not preferable to use polymer particles and inorganic particles having opposite signs in the zeta (ξ) potential to each other in an aqueous medium from the viewpoints of preventing the generation of scratches and the fluctuation of the polishing rate described above. In other words, it is preferable that the polymer particles and the inorganic particles have a zeta potential of zero (0) or the same sign.

The sign for the zeta potential of the inorganic particles is determined by the pH of the aqueous medium: In many cases, the zeta potential is positive in a low pH range, and the zeta potential is negative in a high pH range. On the other hand, the sign for the zeta potential of the polymer particles can be adjusted to be negative or positive in a wide pH range by having a specified functional group on the surface of the polymer. Therefore, it is preferable that the zeta potential of the polymer particles is adjusted not to have an opposite sign to the zeta potential shown by the inorganic particle in the pH of the polishing composition which is actually used for polishing. Concretely, it is preferable that when the zeta potential of the inorganic particles is zero (0) or negative, the polymer particles of which zeta potential is adjusted to zero (0) or negative are used, and that when the zeta potential of the inorganic particles is zero (0) or positive, the polymer particles of which zeta potential is adjusted to zero (0) or positive are used.

The polymer particles of which zeta potential is adjusted to have a negative sign can be obtained by introducing at least one member selected from carboxyl group, sulfonate group and salts thereof onto the surface of the polymer particles. In order to introduce the above-mentioned functional group, there can be employed a method of copolymerizing an unsaturated ethylenic monomer having the above-mentioned functional group, a method of carrying out emulsion polymerization with an anionic surfactant, a method of carrying out emulsion polymerization with an agent having an anionic functional group as a polymerization initiator. As the above-mentioned unsaturated ethylenic monomer, there can be used a compound such as acrylic acid, methacrylic acid, itaconic acid, maleic acid, fumaric acid, sodium styrenesulfonate or 2-acrylamide-2-methylpropane sulfonic acid. In addition, as the above-mentioned anionic surfactant, there can be used a salt of a fatty acid, an alkylbenzenesulfonate, an alkylsulfate, an alkylsulfuric ester, a polyoxyethylene alkylsulfuric ester or the like. As the above-mentioned polymerization initiator, there can be used ammonium persulfate, potassium persulfate, sodium persulfate, or the like.

The polymer particles of which zeta potential is adjusted to have a positive sign can be obtained by introducing at least one member selected from amino group and quaternary ammonium salt group on the surface of the polymer particles. In order to introduce the above-mentioned functional group, there can be employed a method of copolymerizing an unsaturated ethylenic monomer having the above-mentioned functional group, a method of carrying out emulsion polymerization with a cationic surfactant, a method of carrying out emulsion polymerization with an agent having a cationic functional group as a polymerization initiator. As the above-mentioned unsaturated ethylenic monomer, there can be used a compound such as dimethylaminoethyl methacrylate, dimethylaminopropyl methacrylamide, vinylpyridine, methacrylamide propyltrimethylammonium chloride or methacryloyloxyethyltrimethylammonium chloride. In addition, as the above-mentioned cationic surfactant, there can be used an alkylamine salt, an alkylated quaternary ammonium salt, a polyoxyethylene alkylamine or the like. As the above-mentioned polymerization initiator, there can be used V-50 (2,2′-azobis(2-methylpropionamidine)dihydrochloride) and the like.

The content of the polymer particles is preferably from 0.1 to 20% by weight, more preferably from 0.2 to 15% by weight, still more preferably from 0.3 to 10% by weight, of the polishing composition, from the viewpoint of increasing the polishing rate.

The content of the inorganic particles is preferably from 0.1 to 50% by weight, more preferably from 0.5 to 40% by weight, still more preferably from 1 to 30% by weight, of the polishing composition, from the viewpoint of increasing the polishing rate and from the viewpoint of costs.

In addition, the ratio of the content (Cp) of the polymer particles in the polishing composition to the content (Ci) of the inorganic particles in the polishing composition, i.e. Cp/Ci, is preferably from 0.03 to 2, from the viewpoint of increasing the polishing rate, more preferably from 0.03 to 1.5, still more preferably from 0.04 to 1, especially preferably:

(I) in a case where Dp/Di is less than 1.0, (0.3−0.3 Dp/Di)≦Cp/Ci≦2;

(II) in a case where Dp/Di is 1.0 or more and Dp is less than 70 nm, Cp/Ci≦(4−2 Dp/Di); and

(III) in a case where Dp/Di is 1.0 or more and Dp is 70 nm or more, Cp/Ci≦(0.8−0.4 Dp/Di).

While a polishing composition composed only of the inorganic particles having an average particle size of from 5 to 170 nm has a low polishing rate, when the ratio of the content of the polymer particles to the content of the inorganic particles satisfies the above-mentioned relationship, and the ratio of the average particle size of the polymer particles to the average particle size of the inorganic particles satisfies the above-mentioned relationship, the polishing rate is remarkably increased. Although the reason therefor is not clear, it is presumably as follows. If a strong shearing force is applied to a polishing composition during polishing, the polymer particles are aggregated with incorporating the inorganic particles into the polymer particles, so that an aggregate composite particle having high polishing power is formed (see FIG. 1).

On the other hand, when the relationship of the average particle size of the polymer particles and the average particle size of the inorganic particles falls outside the range specified above, namely when the particle size of the polymer particles is exceeding larger than the particle size of the inorganic particles, it is presumed that the shape of the aggregate composite particle formed during polishing is in a state that the inorganic particles are embedded in the polymer particles, so that the polishing power is conversely lowered. Therefore, the effect of increasing the polishing rate cannot be exhibited. In addition, when the ratio of the content of the polymer particles to the content of the inorganic particles falls outside the range specified above, namely when the content of the polymer particles is exceeding small, it is presumed that the amount of an aggregate composite particle formed during polishing is too little, so that an effect of increasing the polishing rate is not exhibited. When the content of the polymer particles is exceedingly large, it is presumed that the shape of the aggregate composite particle formed during polishing is in a state that the inorganic particles are embedded in the polymer particles, so that the polishing power is conversely lowered. Therefore, the effect of increasing the polishing rate cannot be exhibited.

Among the above-mentioned (I) to (III), it is preferable in the polishing composition that in a case where Dp/Di is 1.0 or more and Dp is less than 70 nm, Cp/Ci≦(4−2 Dp/Di), from the viewpoint of reducing the surface roughness.

As the aqueous medium in the present invention, there can be used water and a mixed medium of water and a water-miscible solvent such as an alcohol. It is preferable to use water such as ion-exchanged water. The content of the aqueous medium is preferably from 50 to 99.8% by weight, more preferably 60 to 99% by weight, of the polishing composition, from the viewpoint of increasing the polishing rate and from the viewpoint of preventing precipitation and separation of the inorganic particles or polymer particles.

The polishing composition of the present invention can be prepared by adding polymer particles and inorganic particles to an aqueous medium. Concretely, the polishing composition can be prepared by a process comprising mixing an aqueous dispersion containing polymer particles with an aqueous dispersion containing inorganic particles; a process comprising adding inorganic particles to an aqueous dispersion containing polymer particles; or a process comprising adding polymer particles to an aqueous dispersion containing inorganic particles. Among them, the process comprising mixing an aqueous dispersion containing polymer particles with an aqueous dispersion containing inorganic particles is easily carried out and preferable.

The aqueous dispersion containing polymer particles can be prepared, for instance, according to the following process: a process comprising polymerizing an unsaturated ethylenic monomer using an aqueous medium, or copolymerizing an unsaturated ethylenic monomer with other monomer as occasion demands, thereby directly giving polymer particles formed and an aqueous medium containing the polymer particles; a process comprising polymerizing an unsaturated ethylenic monomer using an organic solvent, or copolymerizing an unsaturated ethylenic monomer with other monomer as occasion demands, subjecting the polymer particles formed and the organic solvent containing the polymer particles to solvent substitution to an aqueous medium by distillation or the like, to give an aqueous dispersion; a process comprising polymerizing an unsaturated ethylenic monomer using an aqueous medium or an organic solvent, drying the resulting polymer, and pulverizing or the like, and thereafter re-dispersing the resulting powder in an aqueous medium to give an aqueous medium. Among them, the process comprising polymerizing an unsaturated ethylenic monomer using an aqueous medium, or copolymerizing an unsaturated ethylenic monomer with other monomer as occasion demands, thereby directly giving polymer particles formed and an aqueous medium containing the polymer particles as a dispersion is preferable, because the process is convenient, and the control of the average particle size of the resulting polymer particles is facilitated.

The aqueous dispersion containing inorganic particles can be prepared, for instance, according to the following process: a process comprising further pulverizing powdery inorganic particles as occasion demands, adding the resulting powder to an aqueous medium, and more forcibly dispersing the powder by a mechanical power such as ultrasonication, agitation or kneading; and a process comprising growing inorganic particles in an aqueous medium. Among them, the process comprising growing inorganic particles in an aqueous medium is preferable because the resulting inorganic particles are stably dispersed in a state of primary particles and the control of the particle size is facilitated.

When the polishing composition is prepared, it is preferable that the inorganic particles and the polymer particles always do not have opposite signs for the zeta potential in an aqueous medium. For instance, when the aqueous dispersion containing inorganic particles is mixed with the aqueous dispersion containing polymer particles, it is preferable that the pH of the aqueous dispersion is adjusted before mixing so that the zeta potential of the inorganic particles would not take an opposite sign in the zeta potential of the polymer particles due to change in pH of the aqueous dispersion of the inorganic particles through its isoelectric point.

The polishing composition can optionally contain various additives. The additives include a pH adjusting agent, a dispersion stabilizer, an oxidizing agent, a chelating agent, a preservative, and the like.

The pH adjusting agent includes basic substances such as an aqueous ammonia, potassium hydroxide, sodium hydroxide and water-soluble organic amines, and acidic substances including organic acids such as acetic acid, oxalic acid, succinic acid, glycolic acid, malic acid, citric acid and benzoic acid, and inorganic acids such as nitric acid, hydrochloric acid, sulfuric acid and phosphoric acid.

The dispersion stabilizer includes surfactants such as anionic surfactants, cationic surfactants and nonionic surfactants, polymeric dispersants such as polyacrylic acids or salts thereof, acrylate copolymers and ethylene oxide-propylene oxide block copolymers (Pluronics), and the like.

The oxidizing agent includes peroxides, permanganic acid or salts thereof, chromic acid or salts thereof, nitric acid or salts thereof, peroxo acid or salts thereof, oxyacid or salts thereof, metal salts, sulfuric acid, and the like.

The chelating agent includes polycarboxylic acids such as oxalic acid, succinic acid, phthalic acid and trimellitic acid; hydroxycarboxylic acids such as glycolic acid, malic acid, citric acid and salicylic acid; polyaminocarboxylic acids such as nitrilotriacetic acid and ethylenediaminetetraacetic acid; polyvalent phosphonic acids such as aminotri(methylenephosphonic acid) and 1-hydroxyethylidene-1,1-diphosphonic acid, and the like.

The preservative includes benzalkonium chloride, benzethonium chloride, 1,2-benzisothiazolin-3-one, and the like.

It is preferable that the pH of the polishing composition is appropriately determined depending upon the kinds of objects to be polished and required properties. For instance, it is preferable that the pH of the polishing composition is preferably from 2 to 12, from the viewpoints of the cleanability of the objects to be polished, the anti-corrosiveness of the working machine, and the safety of the operator. In addition, when the object to be polished is a semiconductor wafer, a semiconductor element, or the like, especially a silicon substrate, a poly-silicon substrate, a silicon oxide film, or the like, the pH of the polishing composition is more preferably from 7 to 12, still more preferably from 8 to 12, especially preferably from 9 to 11, from the viewpoints of increasing the polishing rate and improving the surface qualities. Further, in a case where the object to be polished is a substrate for precision parts mainly made of a metal, such as an Ni—P plated aluminum alloy substrate, the pH is more preferably from 2 to 9, especially preferably from 3 to 8, from the viewpoints of increasing the polishing rate and improving the surface qualities. The pH can be adjusted by adding the above-mentioned pH adjusting agent properly in a desired amount as occasion demands.

The polishing process for the object to be polished of the present invention comprises polishing an object to be polished with the polishing composition of the present invention, or a composition prepared by mixing each component so as to give the composition of the polishing composition of the present invention, whereby the substrate for precision parts can be especially suitably produced.

The material for objects to be polished which are the subjects of the present invention includes, for instance, metals or metalloids such as silicon, aluminum, nickel, tungsten, copper, tantalum and titanium; alloys made of these metals as main components; glassy substances such as glass, glassy carbon and amorphous carbons; ceramic materials such as alumina, silicon dioxide, silicon nitride, tantalum nitride and titanium nitride; resins such as polyimide resins; and the like. Especially, in a case where the polishing composition of the present invention is used when polishing a substrate having silicon dioxide film formed on the surface to be polished such as a glass or PE-TEOS (Plasma Enhanced-Tetraethoxysilane) substrate, the efficient polishing can be carried out.

The shape for these objects to be polished is not particularly limited. For instance, those having shapes containing planar portions such as disks, plates, slabs and prisms, or shapes containing curved portions such as lenses can be subjects for polishing with the polishing composition of the present invention. Among them, those having the disk-shaped objects to be polished are preferable in polishing.

The polishing composition of the present invention can be favorably used in polishing the substrate for precision parts. For instance, the polishing composition of the present invention is suitable for polishing semiconductor substrates; substrates for magnetic recording media such as magnetic discs, optical discs and opto-magnetic discs; photomask substrates; glass for liquid crystals; optical lenses; optical mirrors; optical prisms; and the like. The polishing of the semiconductor substrates comprises the steps of polishing a silicon wafer (bare wafer), forming separation film for an embedding element, subjecting a dielectric film to planarization, forming an embedded metal line, and forming embedded capacitor, and the like.

The polishing process for a substrate to be polished with the polishing composition of the present invention includes a process of polishing an object to be polished by pressing a jig for supporting the above-mentioned object to be polished against an abrasive disk attached to an abrasive cloth such as an organic polymer-based nonwoven fabric, or clamping the above-mentioned object to be polished with an abrasive disk attached to an abrasive cloth; feeding the polishing composition of the present invention to the surface of the object to be polished; and moving the abrasive disk or the object to be polished, with applying a given pressure.

As described above, the polishing rate can be increased by using the polishing composition of the present invention.

The polishing composition of the present invention especially has an effect in the polishing process, and the polishing composition of the present invention can be similarly applied to a process other than the polishing process, for instance, a lapping process, and the like.

### EXAMPLES

The expression “% by weight” in Examples is based on an entire amount of an aqueous dispersion of the polymer particles or an entire amount of a polishing composition. The expression “parts” means parts by weight. Also, the average particle size of the polymer particles is a value determined by electrophoretic light scattering (ELS) spectrophotometer (commercially available from Otsuka Electronics Co., Ltd. under the trade name of Electrophoretic Light Scattering Spectrophotometer (Laser Zeta Potentiometer) ELS8000). The average particle size of the inorganic particles (commercially available from Bayer Ltd. under the trade name of Levasil 50CK, effective ingredient: 30% by weight, average particle size: 85 nm) is a value obtained by ultracentrifugation analysis method, and all the other average particle sizes are obtained according to BET method.

### Preparation Example 1

### [Preparation of Polymer Particles (a)]

A 2-L separable flask was charged with 9.5 parts of styrene, 15.2 parts of a sodium alkylbenzenesulfonate (commercially available from Kao Corporation under the trade name of NEOPELEX F-25, effective ingredient: 25% by weight), 0.95 parts of an ethylene oxide adduct of alkylbenzene (commercially available from Kao Corporation under the trade name of EMULGEN 920) and 74.1 parts of ion-exchanged water, and the air inside the flask was substituted with nitrogen gas, and the temperature was raised to 65° C. The amount 0.19 parts of potassium persulfate was added to the flask, and the polymerization was carried out for 3 hours, to give an aqueous dispersion of the polymer particles. The polymer particles had an average particle size of 40 nm.

### Preparation Example 2

### [Preparation of Polymer Particles (b)]

A 2-L separable flask was charged with 15 parts of styrene, 3 parts of a potassium salt of a fatty acid (commercially available from Kao Corporation under the trade name of KS SOAP), and 82 parts of ion-exchanged water, and the air inside the flask was substituted with nitrogen gas, and the temperature was raised to 65° C. The amount 0.023 parts of potassium persulfate was added to the flask, and the polymerization was carried out for 3 hours, to give an aqueous dispersion of the polymer particles. The polymer particles had an average particle size of 54 nm.

### Preparation Example 3

### [Preparation of Polymer Particles (c)]

A 2-L separable flask was charged with 30 parts of styrene, 1.5 parts of a potassium salt of a fatty acid (commercially available from Kao Corporation under the trade name of KS SOAP), and 68.5 parts of ion-exchanged water, and the air inside the flask was substituted with nitrogen gas, and the temperature was raised to 65° C. The amount 0.06 parts of potassium persulfate was added to the flask, and the polymerization was carried out for 3 hours, to give an aqueous dispersion of the polymer particles. The polymer particles had an average particle size of 80 nm.

### Preparation Example 4

### [Preparation of Polymer Particles (d)]

There were mixed together 29.4 parts of styrene, 6.0 parts of sodium p-styrenesulfonate, 6.0 parts of a sodium alkylbenzenesulfonate (commercially available from Kao Corporation under the trade name of NEOPELEX F-25, effective ingredient: 25% by weight), 0.06 parts of potassium persulfate and 25.5 parts of ion-exchanged water, with a homomixer with stirring, to give a monomer emulsion. Next, a 2-L separable flask was charged with 38.5 parts of ion-exchanged water, 0.03 parts of potassium persulfate, and 6.2 parts of the previously prepared monomer emulsion, and the air inside the flask was substituted with nitrogen gas, and the temperature was raised to 85° C. to react the monomer emulsion. Thereafter, the remaining 55.4 parts of the previously prepared monomer emulsion was fed to the flask at a given rate over a period of 2.5 hours, to give an aqueous dispersion of the polymer particles. The polymer particles had an average particle size of 102 nm.

### Preparation Example 5

### [Preparation of Polymer Particles (e)]

There were mixed together 30 parts of styrene, 1.5 parts of a potassium salt of a fatty acid (commercially available from Kao Corporation under the trade name of KS SOAP), 0.06 parts of potassium persulfate and 60 parts of ion-exchanged water, with a homomixer with stirring, to give a monomer emulsion. Next, a 2-L separable flask was charged with 8.5 parts of ion-exchanged water, 0.017 parts of potassium persulfate, and 4.6 parts of the previously prepared monomer emulsion, and the air inside the flask was substituted with nitrogen gas, and the temperature was raised to 80° C. to react the monomer emulsion. Thereafter, the remaining 86.9 parts of the previously prepared monomer emulsion was fed to the flask at a given rate over a period of 5 hours, to give an aqueous dispersion of the polymer particles. The polymer particles had an average particle size of 138 nm.

### Preparation Example 6

### [Preparation of Polymer Particles (f)]

A 2-L separable flask was charged with 27 parts of styrene, 3 parts of 55%-divinylbenzene, 1.5 parts of a potassium salt of a fatty acid (commercially available from Kao Corporation under the trade name of KS SOAP), and 68.5 parts of ion-exchanged water, and the air inside the flask was substituted with nitrogen gas, and the temperature was raised to 65° C. The amount 0.06 parts of potassium persulfate was added to the flask, and the polymerization was carried out for 3 hours, to give an aqueous dispersion of the polymer particles. The polymer particles had an average particle size of 71 nm.

The particle size and the solid ingredient (effective ingredient of inorganic particles) of the aqueous dispersion of the inorganic particles used in the present examples are shown in Table 1.

TABLE 1

| | | | | Average | |
|---|---|---|---|---|---|
| | | | | Particle | Solid |
| Kind | | Trade Name | Manufacturer | Size | Ingredient |
| (1) | Colloidal | Cataloid SI-30 | CATALYSTS & | 11 nm | 30% |
| | Silica | | CHEMICALS | | |
| | | | INDUSTRIES CO., LTD. | | |
| (2) | Colloidal | Cataloid SI-50 | CATALYSTS & | 26 nm | 50% |
| | Silica | | CHEMICALS | | |
| | | | INDUSTRIES CO., LTD. | | |
| (3) | Colloidal | Cataloid SI-45P | CATALYSTS & | 45 nm | 40% |
| | Silica | | CHEMICALS | | |
| | | | INDUSTRIES CO., LTD. | | |
| (4) | Colloidal | Levasil 50CK | Bayer Ltd. | 85 nm | 30% |
| | Silica | | | | |
| (5) | Colloidal | Spherica Slurry 160 | CATALYSTS & | 160 nm | 16% |
| | Silica | | CHEMICALS | | |
| | | | INDUSTRIES CO., LTD. | | |
| (6) | Colloidal | Syton HT-50F | Du Pont Kabushiki | 45 nm | 40% |
| | Silica | | Kaisha | | |

### Example 1

The amount 23.3 parts of ion-exchanged water was added to and mixed with 10 parts of an aqueous dispersion of the polymer particles (a) obtained in Preparation Example 1, out of which the polymer particles constitute 3 parts, with stirring. In an agitated state, 66.7 parts of the aqueous dispersion of colloidal silica (1) (commercially available from CATALYSTS & CHEMICALS INDUSTRIES CO., LTD. under the trade name of Cataloid SI-30, effective ingredient: 30% by weight, average particle size: 11 nm), out of which the inorganic particles constitute 20 parts, to give a polishing composition. As occasion demands, the pH of the polishing composition was adjusted with an aqueous potassium hydroxide to 10.5 to 11.5.

The polishing test was carried out using the polishing composition as prepared above under the following conditions, and evaluated.

(1) Polishing Conditions

As a substrate to be polished, there was used one in which silicon oxide film is formed on an 8-inch (200 mm) silicon substrate in a thickness of 2000 nm by plasma TEOS method, and the resulting substrate was cut into a piece having 40 mm each side. As the polishing machine, there was used a single-sided polishing machine (product number: MA-300, commercially available from Musasino Denshi K. K.). As the polishing pad, there was used IC-1000 050(P) Type 52/S400 12″PJ (trade name, commercially available from RODEL NITTA K. K.). In addition, the polishing load was 39.2 kPa, and the feed amount of the polishing composition was 50 ml/min. The number of rotations of the disc was 90 r/min, and the number of rotations of the head was 90 r/min, and the disc and the head were rotated unidirectionally. The polishing time was 2 minutes.

(2) Calculation of Polishing Rate

The polishing rate was obtained by carrying out polishing under the above-mentioned conditions, determining a thickness of a silicon oxide film on the substrate to be polished before and after polishing, and dividing the thickness by the polishing time as expressed by the following equation:

Polishing Rate (nm/min)=[Thickness (nm) Before Polishing−Thickness (nm) After Polishing]/Polishing Time (min)

The film thickness was determined with a spectrometric film thickness measuring system (trade name: LAMBDA ACE VM-1000, commercially available from DAINIPPON SCREEN MFG. CO., LTD.).

### Examples 2 to 7 and Comparative Examples 1 to 6

### [Influence of Average Particle Size of Inorganic Particles]

Each polishing composition was prepared by mixing the inorganic particles and the polymer particles in the same manner as in Example 1 in accordance with the contents (% by weight) shown in Table 2. The silicon oxide film was polished with the resulting polishing composition in the same manner as in Example 1, and evaluated.

TABLE 2

| | Inorganic Particles | | | Polymer Particles | | | | | |
|---|---|---|---|---|---|---|---|---|---|
| | | Average | | | Average | | | | |
| | | Particle | Content | | Particle | Content | | Ratio of | Polishing |
| | | Size | (Effective | | Size | (Effective | | Contents | Rate |
| | Kind | Di (nm) | Ingredient) | Kind | Dp (nm) | Ingredient) | Di + 50 nm | (Cp/Ci) | (nm/min) |
| Ex. 1 | (1) | 11 | 20 | a | 40 | 3 | 61 | 0.15 | 130 |
| Comp. | (1) | 11 | 20 | — | — | — | — | — | 30 |
| Ex. 1 | | | | | | | | | |
| Ex. 2 | (2) | 26 | 13 | a | 40 | 3 | 76 | 0.23 | 350 |
| Comp. | (2) | 26 | 13 | — | — | — | — | — | 110 |
| Ex. 2 | | | | | | | | | |
| Ex. 3 | (3) | 45 | 13 | b | 54 | 3 | 95 | 0.23 | 390 |
| Ex. 4 | (3) | 45 | 13 | f | 71 | 3 | 95 | 0.23 | 430 |
| Comp. | (3) | 45 | 13 | — | — | — | — | — | 180 |
| Ex. 3 | | | | | | | | | |
| Ex. 5 | (4) | 85 | 13 | c | 80 | 3 | 135 | 0.23 | 650 |
| Comp. | (4) | 85 | 13 | — | — | — | — | — | 210 |
| Ex. 4 | | | | | | | | | |
| Ex. 6 | (5) | 120 | 13 | e | 138 | 3 | 170 | 0.23 | 560 |
| Comp. | (5) | 120 | 13 | — | — | — | — | — | 90 |
| Ex. 5 | | | | | | | | | |
| Ex. 7 | (5) | 160 | 13 | e | 138 | 3 | 210 | 0.23 | 140 |
| Comp. | (5) | 160 | 13 | — | — | — | — | — | 70 |
| Ex. 6 | | | | | | | | | |

It can be seen from the results of Table 2 that the compositions of Examples 1 to 7 in which the inorganic particles and the polymer particles are used together have remarkably increased polishing rates as compared to those of the compositions of Comparative Examples 1 to 6 which are composed only of the inorganic particles.

### Examples 2, 3, 5 and 8 to 11 and Comparative Examples 2 to 4 and 7 to 10

Each polishing composition was prepared by mixing the inorganic particles and the polymer particles in the same manner as in Example 1 in accordance with the contents (% by weight) shown in Table 3. The silicon oxide film was polished with the resulting polishing composition in the same manner as in Example 1, and evaluated.

TABLE 3

| | Inorganic Particles | | | Polymer Particles | | | | | | | |
|---|---|---|---|---|---|---|---|---|---|---|---|
| | | Average | | | Average | | | | | | |
| | | Particle | Content | | Particle | Content | | | Ratio of | Polishing | Ratio of |
| | | Size | (Effective | | Size | (Effective | | Determin- | Contents | Rate | Polishing |
| | Kind | Di (nm) | Ingredient) | Kind | Dp (nm) | Ingredient) | Di + 50 nm | ation* | (Cp/Ci) | (nm/min) | Rate(**) |
| Ex. 2 | (2) | 26 | 13 | a | 40 | 3 | 76 | Within range | 0.23 | 350 | 3.2 |
| Ex. 8 | (2) | 26 | 13 | b | 54 | 1 | 76 | Within range | 0.08 | 190 | 1.7 |
| Comp. | (2) | 26 | 13 | c | 80 | 1 | 76 | Outside range | 0.08 | 140 | 1.3 |
| Ex. 7 | | | | | | | | | | | |
| Comp. | (2) | 26 | 13 | — | — | — | — | — | — | 110 | 1.0 |
| Ex. 2 | | | | | | | | | | | |
| Ex. 3 | (3) | 45 | 13 | b | 54 | 3 | 95 | Within range | 0.23 | 390 | 2.2 |
| Ex. 9 | (3) | 45 | 13 | c | 80 | 0.5 | 95 | Within range | 0.04 | 320 | 1.8 |
| Comp. | (3) | 45 | 13 | d | 102 | 0.5 | 95 | Outside range | 0.04 | 180 | 1.0 |
| Ex. 8 | | | | | | | | | | | |
| Comp. | (3) | 45 | 13 | e | 138 | 0.5 | 95 | Outside range | 0.04 | 200 | 1.1 |
| Ex. 9 | | | | | | | | | | | |
| Comp. | (3) | 45 | 13 | — | — | — | — | — | — | 180 | 1.0 |
| Ex. 3 | | | | | | | | | | | |
| Ex. 10 | (4) | 85 | 13 | b | 54 | 5 | 135 | Within range | 0.38 | 360 | 1.7 |
| Ex. 5 | (4) | 85 | 13 | c | 80 | 3 | 135 | Within range | 0.23 | 650 | 3.1 |
| Ex. 11 | (4) | 85 | 13 | d | 102 | 3 | 135 | Within range | 0.23 | 600 | 2.9 |
| Comp. | (4) | 85 | 13 | e | 138 | 3 | 135 | Outside range | 0.23 | 130 | 0.6 |
| Ex. 10 | | | | | | | | | | | |
| Comp. | (4) | 85 | 13 | — | — | — | — | — | — | 210 | 1.0 |
| Ex. 4 | | | | | | | | | | | |

Note *Determination was made as “within the range” for cases satisfying Dp ≦ Di + 50, and made as “outside the range” for other cases.
**Ratio to the polishing rate with no polymer particles.

It can be seen from the results of Table 3 that the compositions of Examples 2, 3, 5 and 8 to 11 have remarkably increased polishing rates as compared to those of the compositions of Comparative Examples 2 to 4 which are composed only of the inorganic particles. However, in each of Comparative Examples 7 to 10 where the average particle size Dp of the polymer particles exceeds Di+50, even though the polymer particles are formulated, the polishing rate is substantially the same level as or rather lowered as compared to the case composed only of the inorganic particles.

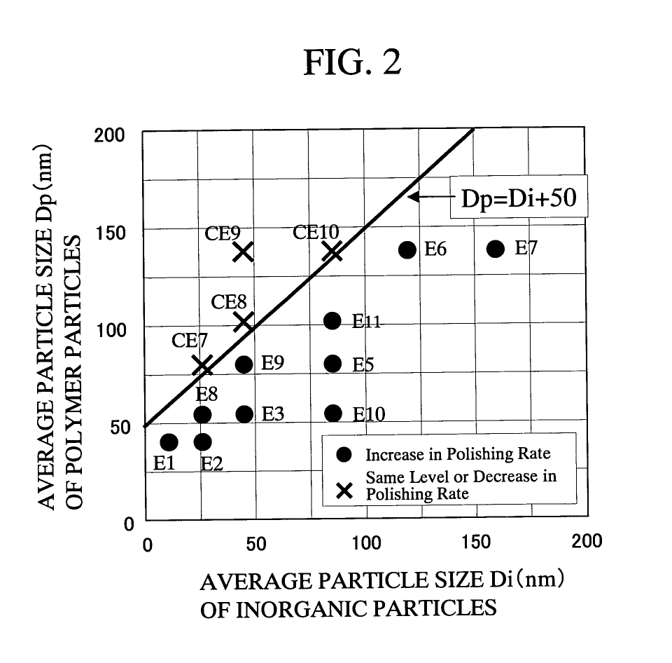

In addition, the results of the average particle size Dp of the polymer particles and the average particle size Di of the inorganic particles in connection with the polishing rate in Examples 1 to 3 and 5 to 11 and Comparative Examples 7 to 10 are shown in FIG. 2. It can be seen from FIG. 2 that all of Examples 1 to 3 and 5 to 11 satisfying the formula, Dp≦Di+50 nm, have increased polishing rates, whereas all of Comparative Examples 7 to 10 not satisfying the above formula have the substantially the same level of the polishing rates or lower.

### Examples 2, 3 and 9 to 20 and Comparative Examples 2 to 4

Each polishing composition was prepared by mixing the inorganic particles and the polymer particles in the same manner as in Example 1 in accordance with the contents (% by weight) shown in Table 4. The silicon oxide film was polished with the resulting polishing composition in the same manner as in Example 1, and evaluated.

TABLE 4

| | Inorganic Particles | | | Polymer Particles | | | | | | |
|---|---|---|---|---|---|---|---|---|---|---|
| | | Average | | | Average | | | | | |
| | | Particle | Content | | Particle | Content | | Ratio of | Polishing | Ratio of |
| | | Size | (Effective | | Size | (Effective | | Contents | Rate | Polishing |
| | Kind | Di (nm) | Ingredient) | Kind | Di (nm) | Ingredient) | Di + 50 nm | (Cp/Ci) | (nm/min) | Rate(**) |
| Ex. 12 | (4) | 85 | 13 | b | 54 | 3 | 135 | 0.23 | 280 | 1.3 |
| Ex. 10 | (4) | 85 | 13 | b | 54 | 5 | 135 | 0.38 | 360 | 1.7 |
| Comp. | (4) | 85 | 13 | — | — | — | — | — | 210 | 1.0 |
| Ex. 4 | | | | | | | | | | |
| Ex. 13 | (2) | 26 | 13 | a | 40 | 1 | 76 | 0.08 | 250 | 2.3 |
| Ex. 2 | (2) | 26 | 13 | a | 40 | 3 | 76 | 0.23 | 350 | 3.2 |
| Ex. 14 | (2) | 26 | 13 | a | 40 | 7 | 76 | 0.54 | 380 | 3.5 |
| Comp. | (2) | 26 | 13 | — | — | — | — | — | 110 | 1.0 |
| Ex. 2 | | | | | | | | | | |
| Ex. 15 | (3) | 45 | 13 | b | 54 | 1 | 95 | 0.08 | 270 | 1.5 |
| Ex. 3 | (3) | 45 | 13 | b | 54 | 3 | 95 | 0.23 | 390 | 2.2 |
| Ex. 16 | (3) | 45 | 13 | b | 54 | 5 | 95 | 0.38 | 490 | 2.7 |
| Ex. 17 | (3) | 45 | 13 | b | 54 | 10 | 95 | 0.77 | 560 | 3.1 |
| Comp. | (3) | 45 | 13 | — | — | — | — | — | 180 | 1.0 |
| Ex. 3 | | | | | | | | | | |
| Ex. 9 | (3) | 45 | 13 | c | 80 | 0.5 | 95 | 0.04 | 320 | 1.8 |
| Ex. 18 | (3) | 45 | 13 | c | 80 | 1 | 95 | 0.08 | 270 | 1.5 |
| Comp. | (3) | 45 | 13 | — | — | — | — | — | 180 | 1.0 |
| Ex. 3 | | | | | | | | | | |
| Ex. 19 | (4) | 85 | 13 | d | 102 | 0.5 | 135 | 0.04 | 360 | 1.7 |
| Ex. 20 | (4) | 85 | 13 | d | 102 | 1 | 135 | 0.08 | 490 | 2.3 |
| Ex. 11 | (4) | 85 | 13 | d | 102 | 3 | 135 | 0.23 | 600 | 2.9 |
| Comp. | (4) | 85 | 13 | — | — | — | — | — | 210 | 1.0 |
| Ex. 4 | | | | | | | | | | |

Note: **Ratio to the polishing rate with no polymer particles.

It can be seen from the results of Table 4 that all of the compositions of Examples 2, 3 and 9 to 20 have remarkably increased polishing rates as compared to those of the compositions of Comparative Examples 2 to 4 composed of the inorganic particles alone.

### Example 21

The amount 56.4 parts of ion-exchanged water was added to and mixed with 13.6 parts of the aqueous dispersion of polymer particles (g) (commercially available from Nippon Paint Co., Ltd., fine particles of acrylic cross-linking resin, trade name; E-151, average particle size: 74 nm), out of which the polymer particles constitute 3 parts, with stirring. In an agitated state, 30 parts of the aqueous dispersion of colloidal silica (commercially available from BAYER LTD. under the trade name of Levasil 50CK, effective ingredient: 30% by weight, average particle size: 85 nm), out of which the inorganic particles constitute 13 parts, to give a polishing composition.

The polishing test was carried out using the polishing composition as prepared above under the following conditions, and evaluated.

(1) Polishing Conditions

As a substrate to be polished, there was used a 95 mm diameter aluminum alloy substrate having a thickness of 0.8 mm and being plated with Ni—P. As the polishing machine, there was used a double-sided 9B polishing machine (commercially available from SPEEDFAM CO., LTD.). As the polishing pad, there was used Belatrix N0058 (trade name, commercially available from Kanebo, LTD.). In addition, the polishing load was 7.8 kPa, and the number of rotations of the disc was 35 r/min. The number of substrates introduced was 10, the feed amount of the polishing composition was 40 ml/min, and the polishing time was 4 minutes.

(2) Calculation of Polishing Rate

The polishing rate was calculated by a weight reduction of the substrate before and after polishing according to the following equations:

Rate of Weight Reduction (g/min)=[Weight Before Polishing (g)−Weight After Polishing (g)]/Polishing Time (min)

Polishing Rate (μm/min)=Rate of Weight Reduction (g/min)/Area of One Side of Substrate (mm²)/Ni—P Plating Density (g/cm³)×10⁶.

In the above equation, an Ni—P plating density of 7.9 g/cm³ was used.

### Comparative Example 11

Thirty parts of an aqueous dispersion of colloidal silica (commercially available from Bayer Ltd. under the trade name of Levasil 50CK, effective ingredient: 30% by weight, average particle size 85 nm), out of which the inorganic particles constitute 13 parts, was added to 70 parts of ion-exchanged water in an agitated state, to give a polishing composition. The plated aluminum substrate was polished with the resulting polishing composition in the same manner as in Example 21, and evaluated.

TABLE 5

| | Inorganic Particles | | | Polymer Particles | | | | | |
|---|---|---|---|---|---|---|---|---|---|
| | | Average | | | Average | | | | |
| | | Particle | Content | | Particle | Content | | Ratio of | Polishing |
| | | Size | (Effective | | Size | (Effective | | Contents | Rate |
| | Kind | Di (nm) | Ingredient) | Kind | Dp (nm) | Ingredient) | Di + 50 nm | (Cp/Ci) | (nm/min) |
| Ex. 21 | (4) | 85 | 9 | a | 74 | 3 | 135 | 0.33 | 50 |
| Comp. | (4) | 85 | 9 | — | — | — | — | — | 15 |
| Ex. 11 | | | | | | | | | |

It can be seen from the results of Table 5 that the polishing composition (Example 21) in which the polymer particles are used together with the inorganic particles have a remarkably increased polishing rate as compared to that of the composition (Comparative Example 11) composed of the inorganic particles alone.

### Example 22

The amount 56.7 parts of ion-exchanged water was added to and mixed with 3.3 parts of the aqueous dispersion of polymer particles (f) obtained in Preparation Example 6, out of which the polymer particles constitute 1 part, with stirring. In an agitated state, 40 parts of the aqueous dispersion of colloidal silica (commercially available from Du Pont Kabushiki Kaisha under the trade name of Syton HT-50F, effective ingredient: 50% by weight, average particle size: 45 nm), out of which the inorganic particles constitute 20 parts, to give a polishing composition. The pH of each of the polishing composition was adjusted to 10 to 11 with an aqueous sodium hydroxide as occasion demands.

The polishing test was carried out using the polishing composition as prepared above under the following conditions, and evaluated.

(1) Polishing Conditions

As a substrate to be polished, there was used a 65 mm diameter crystallized glass substrate having a thickness of 0.6 mm. As the polishing machine, there was used a single-sided polishing machine (product number: MA-300, commercially available from Musasino Denshi K. K.). As the polishing pad, there was used Belatrix N0012 (trade name, commercially available from Kanebo, LTD.). In addition, the polishing load was 14.7 kPa, and the feed amount of the polishing composition was 50 ml/min. The number of rotations of the disc was 90 r/min, and the number of rotations of the head was 90 r/min. The disc and the head was rotated unidirectionally. The polishing time was 10 minutes.

(2) Calculation of Polishing Rate

The polishing rate was calculated by a weight reduction of the substrate before and after polishing according to the following equations.

Rate of Weight Reduction (g/min)=[Weight Before Polishing (g)−Weight After Polishing (g)]/Polishing Time (min)

Polishing Rate (μm/min)=Rate of Weight Reduction (g/min)/Area of One Side of Substrate (mm²)/Glass Density (g/cm³)×10⁶.

In the above equation, a glass density of 2.4 g/cm³ was used.

### Examples 23 to 25 and Comparative Examples 12 and 13

Each polishing composition was prepared by mixing the inorganic particles and the polymer particles in the same manner as in Example 22 in accordance with the contents (% by weight) shown in Table 6. The crystallized glass substrate was polished with the resulting polishing composition in the same manner as in Example 22, and evaluated.

TABLE 6

| | Inorganic Particles | | | Polymer Particles | | | | | |
|---|---|---|---|---|---|---|---|---|---|
| | | Average | | | Average | | | | |
| | | Particle | Content | | Particle | Content | | Ratio of | Polishing |
| | | Size | (Effective | | Size | (Effective | | Contents | Rate |
| | Kind | Di (nm) | Ingredient) | Kind | Dp (nm) | Ingredient) | Di + 50 nm | (Cp/Ci) | (nm/min) |
| Ex. 22 | (6) | 45 | 20 | f | 71 | 1 | 95 | 0.05 | 131 |
| Ex. 23 | (6) | 45 | 20 | f | 71 | 5 | 95 | 0.25 | 368 |
| Ex. 24 | (6) | 45 | 10 | f | 71 | 1 | 95 | 0.10 | 95 |
| Ex. 25 | (6) | 45 | 10 | f | 71 | 5 | 95 | 0.50 | 179 |
| Comp. | (6) | 45 | 20 | — | — | — | — | — | 40 |
| Ex. 12 | | | | | | | | | |
| Comp. | (6) | 45 | 10 | — | — | — | — | — | 19 |
| Ex. 13 | | | | | | | | | |

It can be seen from the results of Table 6 that the polishing compositions of Examples 22 to 25 containing both the inorganic particles and the polymer particles have remarkably increased polishing rates as compared to those of the compositions of Comparative Examples 12 and 13 composed of the inorganic particles alone.

By using the polishing composition of the present invention for polishing a substrate to be polished made of silicon, glass, an oxide, a nitride, a metal or the like, or polishing a coating film, there are exhibited some effects that polishing can be carried out at a high rate without the generation of scratches.

The polishing composition of the present invention can be favorably used in polishing the substrate for precision parts, including semiconductor substrates; substrates for magnetic recording media such as magnetic discs, optical discs and opto-magnetic discs; photomask substrates; glass for liquid crystals; optical lenses; optical mirrors; optical prisms; and the like.

The present invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A polishing composition comprising polymer particles and inorganic particles in an aqueous medium, wherein the inorganic particles have an average particle size of from 5 to 170 nm, and wherein an average particle size Dp (nm) of said polymer particles and an average particle size Di (nm) of said inorganic particles satisfy the following formula (1):
Dp≦Di+50 nm (1)

2. The polishing composition according to claim 1, wherein the polymer particles are made of a thermoplastic resin.

3. The polishing composition according to claim 1, wherein the polymer particles are made of a resin having a glass transition temperature of 200° C. or less.

4. The polishing composition according to claim 1, wherein the polymer particles are made of a resin having a degree of cross-linking of 50 or less.

5. The polishing composition according to claim 1, wherein the inorganic particles are colloidal silica.

6. The polishing composition according to claim 1, wherein a ratio of Cp/Ci is from 0.03 to 2, wherein Cp is a content of the polymer particles in the polishing composition and Ci is a content of the inorganic particles in the polishing composition.

7. A polishing process for a substrate to be polished comprising polishing the substrate to be polished with the polishing composition as defined in any one of claims 1 to 6.

8. A process for improving a rate for polishing a substrate to be polished with the polishing composition as defined in any one of claims 1 to 6.
